(19) United States
(12) Patent Application Publication
(10) Pub. No.: US 2008/0134850 A1
(43) Pub. Date: Jun. 12, 2008

(54) MACHINE AND PROCESS FOR PRODUCING RANDOM SHAPED POTATO PIECES

(75) Inventors: Ronald B. Bates, Boise, ID (US); Richard B. Jensen, Caldwell, ID (US); Bruce T. Pittard, Caldwell, ID (US); David Bruce Walker, Meridian, ID (US)

Correspondence Address: KELLY LOWRY & KELLEY, LLP, 6320 CANOGA AVENUE, SUITE 1650, WOODLAND HILLS, CA, 91367, US

(73) Assignee: J. R. SIMPLOT COMPANY, Boise, ID (US)

(21) Appl. No.: 11/927,339

(22) Filed: Oct. 29, 2007

Related U.S. Application Data
(60) Provisional application No. 60/869,252, filed on Dec. 8, 2006.

(51) Int. Cl. B26D 1/36; B26D 7/08

(52) U.S. Cl. 83/15; 83/403

(57) ABSTRACT

A machine and process are provided for forming small, random sized potato pieces suitable for use in preparing potato hash browns and potato patties and the like. Blanched potatoes are chilled and then swept against a blunt edge resulting in shattering of each potato into relatively small, random-sized pieces. If desired, each blunt shatter-edge can be provided in a knife unit including one or more cross-cut knives to subdivide larger shattered pieces into a smaller size. The produced potato pieces are chilled as by freezing or by chilling to a refrigerated temperature for shipment and/or storage pending finish preparation.

### BACKGROUND OF THE INVENTION

This invention relates generally to an improved and modified cutting or processing machine, and related production process, for producing relatively small and substantially random sized potato pieces suitable for use in preparing potato hash browns and the like. More specifically, this invention relates to an improved processing machine and related production process for shattering potatoes into small random sized pieces.

Potato products such as hash browns and potato patties and the like are well known in the art, wherein these products comprise an aggregation of relatively small potato pieces. Such potato pieces are typically combined into a serving size of a few ounces, and then finish prepared as by frying, grilling, oven baking, etc. In some products, the small potato pieces are consolidated as by pressing into a unitized patty which is then finish prepared for consumption.

In one common form, a variety of cutting machines and related production processes are known for cutting potatoes into small potato pieces such as diced cubes or thin shreds. Alternative processing machines and methods utilize extrusion technology such as ricing equipment wherein cooked or partially cooked potatoes are forced through small openings in an extrusion-type die. Still other communication-type machines and processes are designed to produce small potato pieces by means of a shearing or tearing action. However, in general terms, such known processes and related production equipment typically produces an array of small potato pieces having a generally uniform overall size and shape which is readily apparent in the finish prepared food product. In addition, depending upon the processing parameters, some of these machines and processes will disrupt the cellular potato structure to cause release of a sufficient quantity of potato starch to result in a product that has an undesirably sticky or gummy character.

The improved processing machine and related production process of the present invention are specifically designed for quickly and easily reducing potatoes to smaller pieces having a substantially irregular or random overall size and shape, thereby providing a finish prepared food product having a unique, distinctive, and highly attractive appearance.

### SUMMARY OF THE INVENTION

In accordance with the invention, an improved processing machine and related production process are provided for forming small, substantially random sized potato pieces suitable for use in preparing potato hash browns and the like. Blanched potatoes are chilled and then swept against a blunt edge resulting in shattering of each potato into the desired plurality of relatively small, random-sized pieces, substantially without cutting or extrusion of the potato. If desired, each blunt shatter-edge can be provided in a knife unit including one or more cross-cut knives to subdivide larger already-shattered pieces into a smaller size. The produced potato pieces are chilled as by freezing for shipment and/or storage to await finish preparation.

In the preferred form, potatoes such as whole potatoes in a raw and peeled or unpeeled state are initially cooked at least partially, as by blanching the potatoes in hot water or steam. More particularly, the potatoes are blanched as by heating hot water at a temperature of from about 180 F. to about 195 F., for a period of from about 20 to about 40 minutes. At the conclusion of the blanch step, the potatoes are partially cooked to exhibit a core pulp temperature of from about 165 F. to about 185 F.

The blanched potatoes are then chilled to reduce the core pulp temperature to near freezing, but substantially without freezing the blanched potatoes. In one preferred process, the chilling step comprises a two-step sequence including water quenching in cool water followed by air chilling to reduce the core pulp temperature to about 35 F.

The blanched and chilled potatoes are then processed in a modified cutting machine including at least one and preferably multiple knife units each having a relatively blunt edge for shattering the chilled potatoes into random sized pieces. In the preferred form, the modified cutting machine comprises a modified Model CC cutter available from Urschel Laboratories, Valparaiso, Ind., wherein conventional sharp-edged knife blades at the perimeter of a stationary frame have been replaced by the blunt edge, such as a blunt blade having a leading edge with a dull or blunt thickness on the order of about ¼ inch. Chilled potatoes supplied into the machine are swept by an internally mounted rotary impeller so that the potatoes impact and shatter against the blunt-edged blade on the stationary frame. The shattered potato pieces have a substantially random overall size and shape, while exhibiting a disrupted potato cell structure which is significantly different than that achieved by traditional extrusion-type or communition-type equipment and processes.

If desired, each blunt-edged blade on the stationary frame comprises a portion of a knife unit, wherein each knife unit may additionally include one or more cross-cut and relatively sharp-edged knife blades for subdividing relatively large-sized shattered pieces into smaller pieces. Importantly, when the cross-cut knives are used, each large-sized piece is cut on one or two surfaces thereof, whereby at least two surfaces remain uncut to retain the overall random size and shape appearance of the produced potato pieces.

The produced potato pieces are then chilled or frozen for storage and/or shipment, pending finish preparation as by frying, microwaving, grilling or oven heating or the like. In this regard, the produced potato pieces can be finished prepared in an unassembled hash brown configuration, or in an assembled patty-like shape. Regardless, the random-sized potato pieces provide the finish prepared comestible with a unique and distinct overall appearance, in combination with a pleasing taste and texture.

Other features and advantages of the present invention will become apparent from the following more detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a fragmented perspective view illustrating an exemplary processing machine for use in the present invention;

FIG. 2 is an enlarged elevation view of a portion of the processing machine of FIG. 1, with a portion of an outer shroud removed to reveal in external elevation an internally mounted stationary frame having a plurality of knife units mounted thereon;

FIG. 3 is a top plan view taken generally on the line 3-3 of FIG. 2, and showing a rotary impeller mounted within the stationary frame;

FIG. 4 is a top perspective view of a portion of the processing machine, and depicting a potato carried by an impeller vane into engagement with a knife unit mounted on the stationary frame;

FIG. 5 is an enlarged and fragmented elevation view similar to a portion of FIG. 2, and showing the potato carried by the impeller vane into engagement with the knife unit mounted on the stationary frame;

FIG. 6 is an enlarged and fragmented top perspective view similar to a portion of FIG. 4, and depicting the rotary impeller and frame-mounted knife units in closer detail;

FIG. 7 is an enlarged and fragmented external elevation view of a portion of the stationary frame to depict mounting of an exemplary knife unit thereon;

FIG. 8 is an outboard-side perspective view of the knife unit of FIG. 7;

FIG. 9 is an inboard-side perspective view of the knife unit of FIGS. 7-8;

FIG. 10 is an inboard-side perspective view of the knife unit of FIGS. 7-9 mounted onto the stationary frame;

FIG. 11 is an external perspective view, similar to FIG. 2, but depicting operation of the processing machine to produce random sized potato pieces;

FIG. 12 is a plan view illustrating an approximate single serving of the random sized potato pieces produced in accordance with the invention; and

FIG. 13 is a flow chart illustrating the preferred process in accordance with the invention.

### DETAILED DESCRIPTION OF THE PREFERRED EMBODIMENT

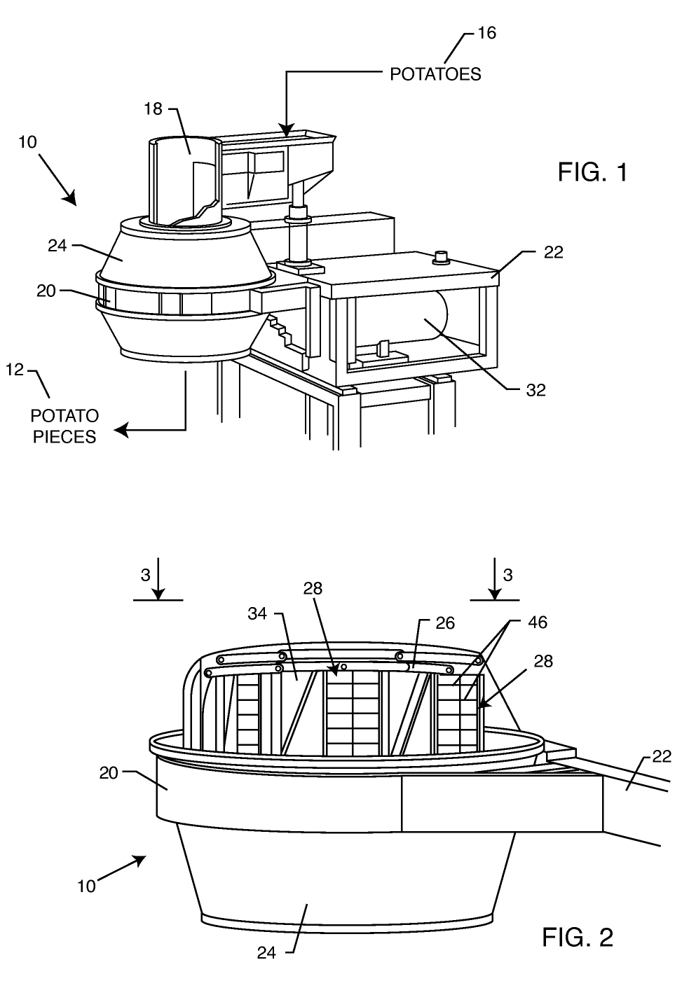

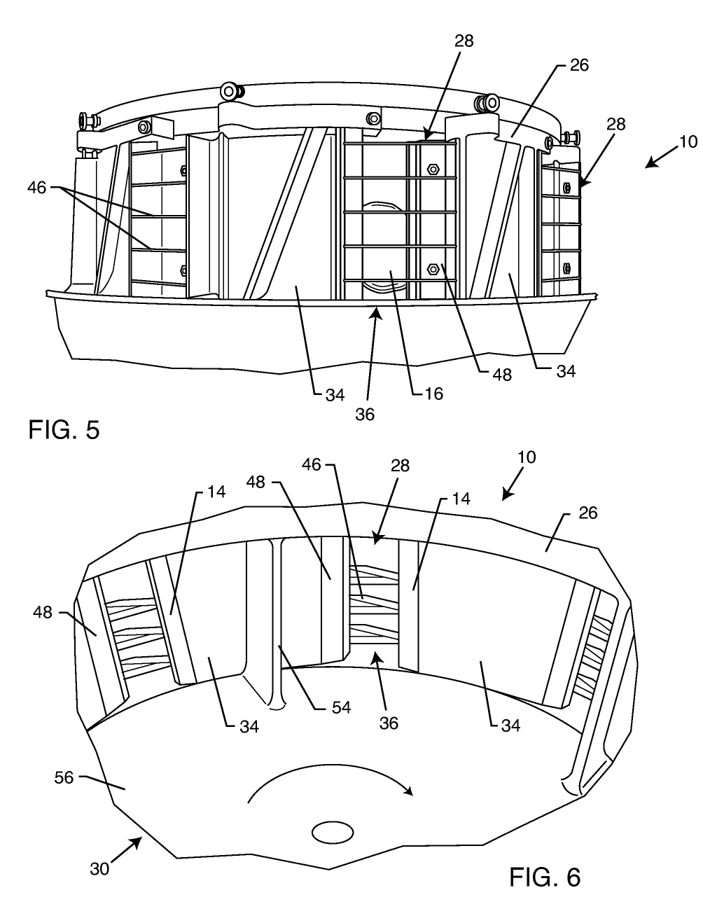

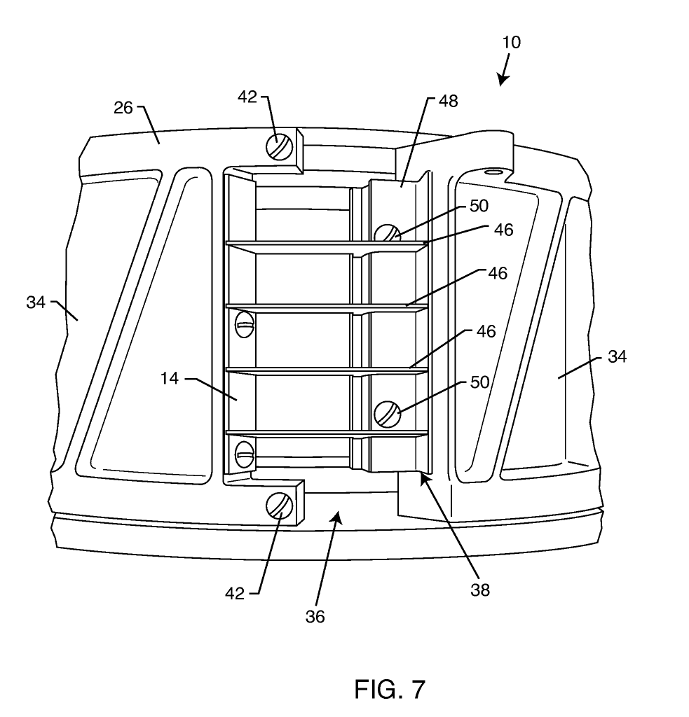

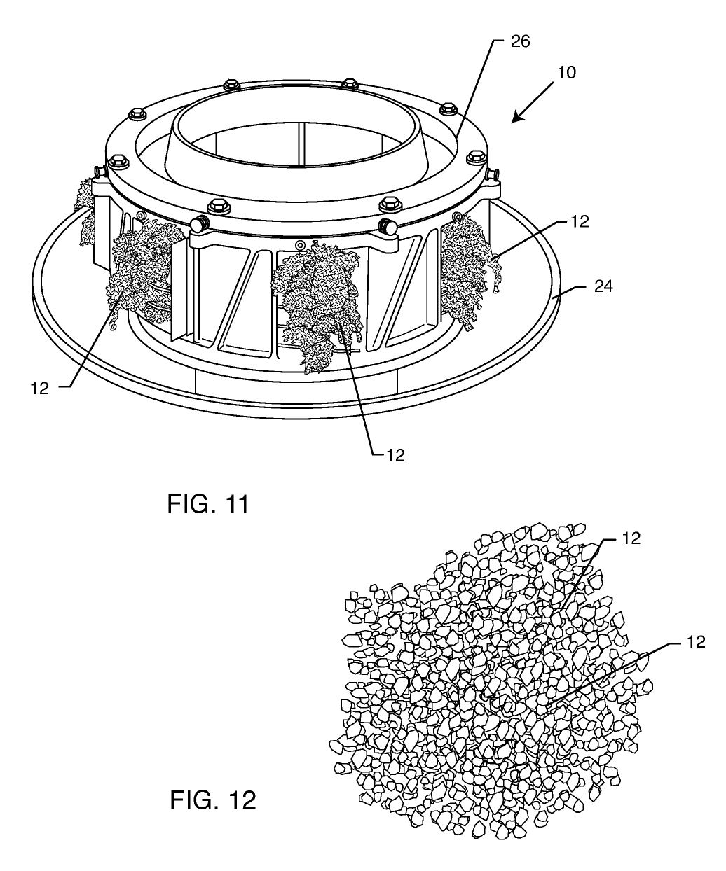

As shown in the exemplary drawings, an improved and modified cutting or processing machine referred to generally in FIGS. 1-7 by the reference numeral 10 is provided for use in producing relatively small potato pieces 12 (FIGS. 11-12) having a substantially random overall size and shape. The processing machine 10 includes a blunt edge, or blunt-edged blade 14 (FIGS. 7-9) against which partially cooked and chilled potatoes 16 are swept to cause the potatoes 16 to shatter into the desired small pieces of random size and shape.

The processing machine 10 and related production process are designed for producing small potato pieces suitable for use in preparing so-called hash brown potato or potato patty products having a unique and distinct overall appearance, in combination with a pleasing taste and texture. In this regard, potato hash browns are typically prepared from an unconnected or loose aggregation of small potato pieces which are finished prepared for eating as by means of frying, grilling or oven heating or the like. By contrast, potato patty products generally comprise a similar aggregation of small potato pieces but wherein the potato pieces are pressed into a typically flattened and substantially unitized patty shape for finish preparation as by means of frying, grilling or oven heating or the like. The processing machine 10 and related production process of the present invention produces small potato pieces of random size and shape, thereby presenting a unique and distinct overall appearance. The potato pieces are produced with relatively minimal disruption of the potato cell structure, and correspondingly minimal release of starch with the above mentioned process, to avoid an undesirably sticky or gummy potato product.

The processing machine 10 generally comprises, in one preferred form, a modified cutting machine such as a modified Model CC cutting machine available from Urschel Laboratories, Valparaiso, Ind. See also U.S. Pat. Nos. 3,139,128 and 5,694,824, which are incorporated by reference herein.

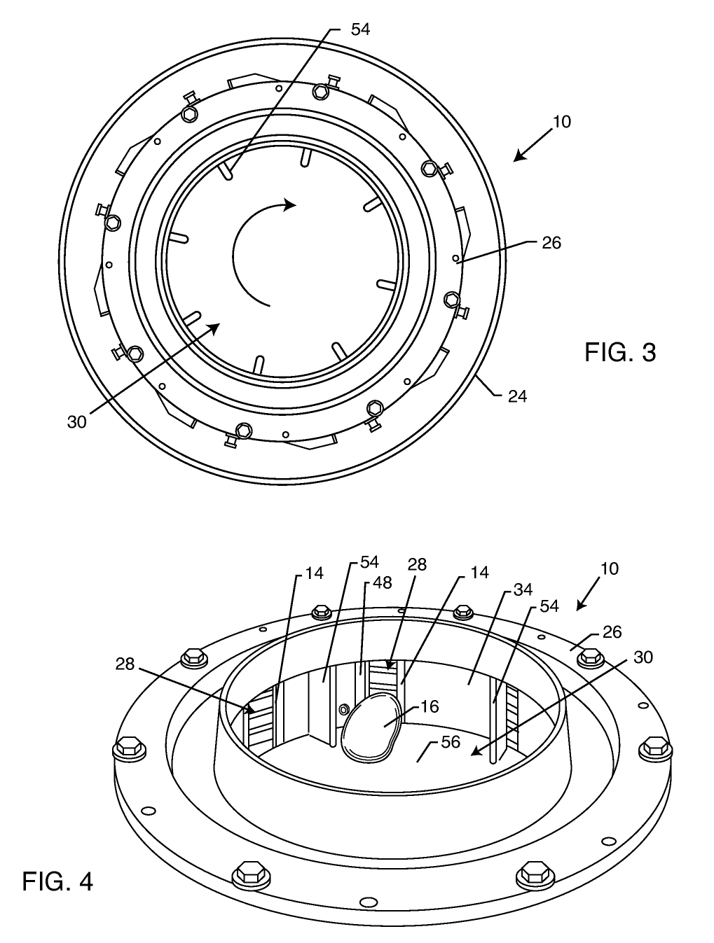

In general terms, the modified processing machine 10 generally comprises an upper hopper or chute 18 (FIG. 1) through which a succession of potatoes is supplied to a processor head 20 mounted in a cantilevered fashion at one side of a support stand 22. The processor head 20 includes a protective outer shroud 24 of upright, generally cylindrical shape encasing a stationary frame 26 (FIGS. 2-7) which is also carried by the support stand 22. The stationary frame 26 in turn supports at least one and preferably multiple knife units 28 (shown best in FIGS. 7-10) each including a blunt-edged blade 14. These knife units 28 are positioned by the stationary frame 26 at the perimeter of an internally mounted impeller 30 (FIGS. 3 and 6) which is rotatably driven by a stand-supported drive motor 32 (FIG. 1) to carry or sweep the potatoes 16 into impact engagement with the blunt-edged blades 14. Importantly, by properly pre-conditioning the potatoes 16 supplied to the machine 10, the impact engagement of the potatoes with the blunt-edged blades 14 causes the potatoes to shatter substantially without cutting into the desired array of small, random sized pieces 12 which are discharged below the processor head 20 for further processing (as viewed schematically in FIG. 1).

More particularly, the stationary frame 26 has a generally cylindrical configuration defined by a circular outer wall 34 (FIGS. 3-7 and 10-11) interrupted by a plurality of perimeter openings 36 (FIGS. 4-7 and 10) formed in the outer wall 34 at generally equiangular intervals around the wall circumference. Each of these perimeter openings 36 defines a station for mounting one of the knife units 28.

In accordance with the invention, each knife unit 28 includes the blunt-edged blade 14 mounted securely at one side of the associated perimeter wall opening 36 for impact engagement by potatoes carried by the internally mounted rotary impeller 30. In the illustrative drawings, with the impeller 30 designed for clockwise rotation (as viewed from above, per FIGS. 3-4 and 6), the blunt-edged blade 14 is secured in an upright position lining or protruding at least a short distance from a downstream-side of the associated perimeter wall opening. Accordingly, the blunt-edged blade 14 defines an upstream or counter-clockwise presented blunt edge for impact engagement by potatoes 16 being swept or driven in a clockwise direction by the rotary impeller 30.

FIGS. 7-9 illustrate the blunt-edged blade 14 in the form of a metal body segment or strip 37 extending vertically between upper and lower mounting tabs 38 having ports 40 formed therein for facilitated removable attachment to the frame outer wall 34 as by means of mounting screws 42 (FIG. 7) or the like. The blade 14 defines an upstream-presented blunt edge 44 having a thickness on the order of about ¼ inch in the radial direction relative to the frame outer wall 34 and the rotary impeller 30. This blunt edge thickness is sufficiently thick and dull or blunt to avoid significant cutting of potatoes 16 impacted therewith during machine operation. However, this blunt edge thickness is also sufficiently strong to produce the desired shattering of properly preconditioned potatoes 16 into the desired array of small random sized potatoes pieces 12.

As shown best in FIG. 7, the blunt-edged blade 14 mounted at each of the perimeter wall openings 36 is sized to leave a substantial residual gap between the installed blade 14 and an opposite or upstream-located side of the associated wall opening 36, thereby permitting the produced shattered potato pieces 12 to travel radially outwardly through this wall gap to the exterior of the stationary frame 26. These potato pieces 12, as viewed in FIG. 11, are thus positioned in spaced relation with the protective outer shroud 24 where they can fall downwardly (FIG. 1) for further processing.

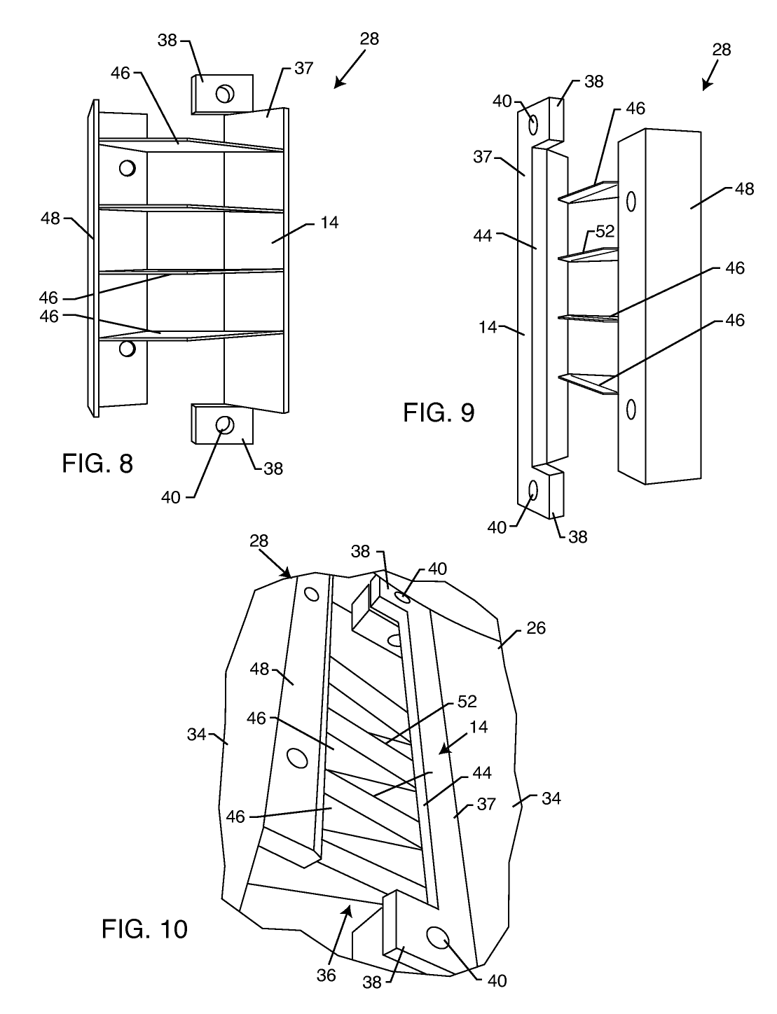

In accordance with one further aspect of the invention, each knife unit 28 may further include at least one and preferably multiple cross-cut knives 46 positioned to subdivide larger shattered potato pieces 12 into small-sized pieces, if desired. As shown in FIGS. 3-11, these cross-cut knives 46 are extend generally horizontally in vertically spaced relation from the associated strip or body segment 37 across the associated perimeter wall opening 36 in a generally upstream direction to an anchor strip 48 adapted for secure mounting to the frame wall 34 at the opposite or upstream side of the associated wall opening 36 by means of additional screws 50 or the like. These cross-cut knives 46, in the preferred form, have a sharp or semi-sharp construction and a generally arcuate shape defining radially inwardly presented cutting edges 52 (FIGS. 9-10) disposed in at least slightly radially outwardly spaced relation to the associated blunt edge 44 of the associated blunt-edged blade 14. This knife unit 28, including the blunt-edged blade 14 and the cross-cut knives 46, can be constructed as a one-piece assembly, or otherwise assembled from multiple components. In a preferred form, as shown best in FIG. 6, the one-piece knife assembly is constructed so that the anchor strip 48 at the upstream end of each perimeter wall opening 36 is spaced radially outwardly from the associated blunt edge 44 from about ⅛ inch to about ½ inch, and most preferably by about 3/16 inch, to prevent undesired plugging during operation.

FIG. 4 shows the processing machine 10 with portions of the outer shroud 24 removed to illustrate a single potato 16 carried by the impeller 30. More particularly, the potato 16 is carried by one of a plurality of perimeter vanes 54 upstanding from a rotary baseplate 56 of the impeller 30 into impact engagement with one of the blunt-edged blades 14 mounted on the stationary frame 26. These perimeter vanes 54 are oriented to extend generally radially, and at a selected angle to carry or sweep each potato 16 generally radially outwardly into impact engagement with the blunt-edged blades 14, as the impeller 30 is rotatably driven. A portion of each potato 16 thus impact-engages the blunt edge 44 resulting in shattering of the potato into the desired array of small random sized pieces. The cross-cut knives 46, when provided, subdivide larger shattered pieces into smaller-sized pieces, with the resulting random sized pieces 12 exiting radially outwardly through the knife units 28 as viewed in FIG. 11.

FIG. 12 depicts an approximate single serving of the random size small potato pieces 12, produced by the processing machine 10 shown and described with respect to FIGS. 1-11. As shown, these potato pieces 12 have a widely distributed range of sizes, and a virtually infinite array of random shapes, to produce a unique and distinct potato product. By shattering properly preconditioned potatoes 16, as opposed to cutting or extruding steps, it is believed that a sufficient quantity of free potato starch is released to permit quick and easy press-formation of the pieces 12 into a patty shape, substantially without requiring the addition of gum-type or other adhering agents. In this regard, it is believed that the specific quantity of free starch in the potato pieces can be regulated by pre-selecting the specific chilled temperature of the potatoes 16, with higher potato temperatures being associated with increased starch release. By contrast, the amount of free starch release is insufficient to detract from the overall appearance and texture of the individually produced pieces 12, whereby the individually separated pieces 12 may also be prepared as an unassembled hash brown-type potato product.

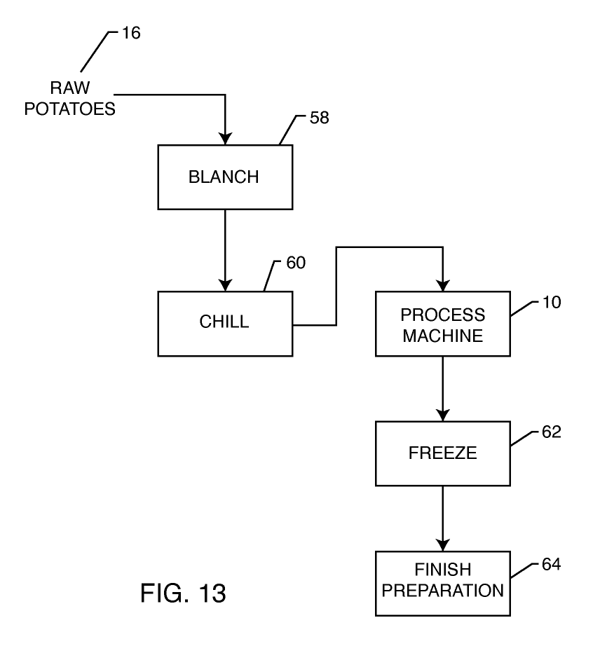

FIG. 13 is a schematic diagram illustrating the preferred process for preconditioning the potatoes 16 for shattering within the process machine 10 to produce the small pieces 12 of random size and shape. In general, this preconditioning process entails partial cooking of the potatoes 16 as by blanching in hot water or steam, following by chilling of the potatoes in cool water and/or chilled air to reduce the temperature of the potatoes sufficiently for shattering against the blunt-edged blades 14 within the processing machine 10.

More particularly, in accordance with a preferred process aspect of the invention, raw potatoes in a large or whole state, peeled or unpeeled, are initially subjecting to a partial cooking step 58 as by blanching in hot water at a temperature of from about 175 F. to about 195 F., and more preferably at about 180 F., for a period of from about 20 to about 40 minutes, and more preferably about 30 minutes. At the conclusion of the blanch step, the potatoes are partially cooked to exhibit a core pulp temperature of from about 165 F. to about 185 F., and more preferably about 175 F.

The blanched potatoes are then subjecting to a chilling step 60 to reduce the core pulp temperature to near freezing, but substantially without freezing the blanched potatoes. In a preferred process, the chilling step comprises a two-step sequence including water quenching in cool water followed by air chilling to reduce the core pulp temperature to from about 33 F. to about 40 F. More particularly, this two-step sequence comprises, in the preferred form, initial temperature reduction by water quenching the blanched potatoes in cool water having a temperature of from about 35 F. to about 60 F., and more preferably about 40 F., for a time period of about 20 to about 45 minutes, sufficient to reduce the core pulp temperature to about 50 F. Thereafter, the partially chilled potatoes are subjected to refrigerated air for a time sufficient to reduce the core pulp temperature to less than about 50 F., more preferably to less than about 45 F., and most preferably to a temperature close to but slightly above freezing such as about 33 F. In this regard, lower core pulp temperatures approaching freezing are preferred since this is believed to enhance production of small shattered pieces with controlled or minimal release of free potato starch, whereas higher core pulp temperatures are believed to result in pastier cut product associated with higher quantities of free starch.

The blanched and chilled potatoes are then delivered to the processing machine 10 as previously shown and described herein for shattering against the blunt-edged blades 14 of the knife units 28. The produced potato pieces 12 exhibit a broad range of small sizes and random shapes. If desired, the cross-cut knives 26 are provided to reduce larger shattered pieces into smaller sizes, with such cross-cut pieces having at least two uncut surfaces to preserve the overall random size and shape appearance of the potato pieces 12.

The produced potato pieces 12 are then typically subjected to a freezing or chilling step 62 followed by suitable packaging for shipment and/or storage awaiting a finish preparation step 64, as by frying, grilling or oven heating as previously described herein.

Although an embodiment of the processing machine 10 and related production process have been described in detail for purposes of illustration, various modifications may be made without departing from the scope and spirit of the invention. Accordingly, no limitation on the invention is intended by way of the foregoing description and accompanying drawings, except as set forth in the appended claims.

What is claimed is:

1. A processing machine for producing random shaped vegetable pieces, said processing machine comprising:
a processor head including a stationary frame surrounding a rotary driven impeller, said frame having at least one opening formed therein, said impeller being adapted for sweeping a vegetable product generally through a circular path toward said at least one opening; and
at least one knife unit mounted on said frame generally at said at least one opening formed in said frame, said at least one knife unit including a blunt-edged blade mounted generally at a downstream side of said at least one opening and defining a blunt edge presented generally in an upstream direction relative to said at least one opening for impact engagement by the vegetable product swept by said impeller;
said blunt edge of said blunt-edged blade having a sufficient thickness for shattering the vegetable product into an array of random shaped pieces substantially without cutting.

2. The processing machine of claim 1 wherein the vegetable product comprises a chilled potato.

3. The processing machine of claim 1 wherein said blunt edge has a thickness of about ¼ inch.

4. The processing machine of claim 1 wherein said stationary frame defines a generally circular outer wall circumscribing said impeller, said wall having said at least one opening formed therein.

5. The processing machine of claim 1 wherein said impeller includes at least one vane for sweeping said vegetable product into impact engagement with said blunt edge of said blunt-edged blade.

6. The processing machine of claim 1 wherein said at least one knife unit further comprises at least one cross-cut knife for cutting relatively large shatter-formed pieces into smaller pieces.

7. The processing machine of claim 1 wherein said at least one knife unit comprises a body segment adapted for removable mounting onto said frame generally at a downstream side of said at least one opening, said body segment defining said blunt edge presented generally in an upstream direction relative to said at least one opening, and said at least one knife unit further comprising an anchor strip adapted for removable mounting generally at an upstream side of said at least one opening, and at least one cross-cut knife extending between said body segment and said anchor strip.

8. The processing machine of claim 7 wherein said at least one cross-cut knife comprises a plurality of cross-cut knives extending in spaced relation to each other between said body segment and said anchor strip.

9. A processing machine for producing random shaped potato pieces, said processing machine comprising:
a processor head including a stationary frame surrounding a rotary driven impeller, said frame defining a generally circular outer wall circumscribing said impeller and having a plurality of openings formed therein at spaced locations about the periphery of said impeller, said impeller being adapted for sweeping a potato product generally through a circular path in succession toward said openings; and
a plurality of knife units each mounted on said frame generally at a respective one of said openings formed in said frame, each of said knife units including a blunt-edged blade mounted generally at a downstream side of the associated one of said openings and defining a blunt edge presented generally in an upstream direction relative said associated opening for impact engagement by the potato product carried by said impeller;
said blunt edge of said blunt-edged blade of each of said knife units having a sufficient thickness for shattering the potato product into an array of random shaped pieces substantially without cutting.

10. The processing machine of claim 9 wherein said blunt edge of each of said knife units has a thickness of about ¼ inch.

11. The processing machine of claim 9 wherein said impeller includes at least one vane for sweeping the potato product into impact engagement with said blunt edge of said blunt-edged blade of each of said knife units.

12. The processing machine of claim 9 wherein each of said knife units further comprises at least one cross-cut knife for cutting relatively large shatter-formed pieces into smaller pieces.

13. The processing machine of claim 9 wherein each of said knife units comprises a body segment adapted for removable mounting onto said frame generally at a downstream side of the associated one of said openings, said body segment defining said blunt edge presented generally in an upstream direction relative to said associate opening, and said knife unit further comprising an anchor strip adapted for removable mounting generally at an upstream side of said associated opening, and at least one cross-cut knife extending between said body segment and said anchor strip.

14. The processing machine of claim 13 wherein said at least one cross-cut knife comprises a plurality of cross-cut knives extending in spaced relation to each other between said body segment and said anchor strip for each of said knife units.

15. A process for producing random shaped vegetable pieces, said process comprising the steps of:
preconditioning vegetable pieces by at least partially cooking and then chilling the vegetable pieces; and
shattering the preconditioned vegetable pieces into small pieces of random shape substantially without cutting, by carrying the preconditioned vegetable pieces into impact engagement with a blunt edge.

16. The process of claim 15 wherein the blunt edge has a thickness of about ¼ inch.

17. The process of claim 15 wherein said preconditioning step comprises blanching the vegetable pieces, followed by chilling the blanched vegetable pieces to a reduced temperature less than about 50° F. without freezing.

18. The process of claim 15 wherein the vegetable pieces are potatoes.

19. A process for producing random shaped potato pieces, said process comprising the steps of:
preconditioning potato pieces by at least partial cooking followed by chilling substantially without freezing; and
shattering the preconditioned potato pieces into smaller pieces of random shape substantially without cutting, by carrying the preconditioned potato pieces into impact engagement with a blunt edge.

20. The process of claim 19 wherein the blunt edge has a thickness of about ¼ inch.

21. The process of claim 19 wherein said preconditioning step comprises blanching the potato pieces, followed by chilling the blanched potato pieces to a reduced core pulp temperature less than about 50° F. without freezing.

22. The process of claim 21 wherein the potato pieces are chilled to a reduced core pulp temperature of less than about 45° F.

23. The process of claim 21 wherein the potato pieces are chilled to a reduced core pulp temperature of about 33° F.

24. The process of claim 19 wherein said shattering step comprises supplying the potato pieces into a processing machine having a rotary impeller mounted within a stationary frame having at least one opening formed therein, and at least one knife unit mounted generally at said at least one opening and defining the blunt edge for impact shatter engagement by potato pieces carried by the impeller.

25. The process of claim 24 further including subdividing relatively large shatter-formed potato pieces with a cross-cut knife carried by said at least one knife unit.
